(19) United States
(12) Patent Application Publication
(10) Pub. No.: US 2010/0326991 A1
(43) Pub. Date: Dec. 30, 2010

(54) Device for securing a lid to a pot

(76) Inventor: Ray Johnson, Aurora, CO (US)

Correspondence Address: Raymond Sun;Law Offices of Raymond Sun, 20 Corporate Park, Suite 155, Irvine, CA, 92606, US

(21) Appl. No.: 12/807,052

(22) Filed: Aug. 25, 2010

Related U.S. Application Data
(63) Continuation-in-part of application No. 12/291,261, filed on Nov. 7, 2008.

(51) Int. Cl. A47J 36/00; F16B 1/00; B65D 51/00; B23P 19/04

(52) U.S. Cl. 220/573.1; 24/302; 220/212.5; 29/700

(57) ABSTRACT

A lid securing device secures a lid to the mouth of a pot. The lid securing device includes a first support piece and a second support piece. Each support piece is made of a fabric material. Each support piece has an upper and a lower panel that are attached together, with a space between each pair of upper and lower panels. The lid securing device further includes first and second adjustable strap systems, with each strap system having a portion that extends in the space between each pair of upper and lower panels of the first and second support pieces, with the portion of the first strap system crossing the portion of the second strap system in each of the spaces between each pair of upper and lower panels. Each strap system further includes a fastener that allows the length of the strap system to be adjusted.

### RELATED CASES

This is a continuation-in-part of co-pending Ser. No. 12/291,261, filed Nov. 7, 2008, whose entire disclosure is incorporated by this reference as though set forth fully herein.

### BACKGROUND OF THE INVENTION

1. Field of the Invention

The present invention is directed to cooking accessories, and in particular, to a removable securing device that facilitates the secure movement or transport of full or partially-full pots or food containers that are holding liquid or solid contents.

2. Description of the Prior Art

It is often desirable to transport a cooking pot or food container (hereinafter collectively referred to as “pot”) that has a non-locked or non-secured lid from one location to another. U.S. Pat. Nos. 4,179,039, 4,735,338 and 7,082,871 all disclose devices that are directed towards fulfilling this purpose. However, these devices all suffer from the drawback that they cannot accommodate pots and containers of different shapes and sizes with lids and handles of different shapes and sizes. Therefore, they can only be used with pots and lids having specific dimensions or features, and cannot be adapted to function as a “one-size-fits-all” type of securing device. In addition, these devices are complex in design and are more difficult to use.

### SUMMARY OF THE DISCLOSURE

It is one objective of the present invention to provide a device that can effectively secure the lid to pots to facilitate the secure movement or transport of full or partially-full pots that are holding liquid or solid contents.

It is another objective of the present invention to provide a device for securing a lid to a pot that can be used with pots of different shapes (cylindrical, rectangular, oval, lipped or non-lipped, etc.) and sizes (small, medium, large in both diameter and depth).

It is yet another objective of the present invention to provide a device for securing a lid to a pot that can be used with pot handles of different shapes and sizes (short or long, plastic or metal, attached at various angles to the pot).

It is a further objective of the present invention to provide a device for securing a lid to a pot that can be used with pot lids of different shapes and sizes (round, rectangular, oval, convex, recessed).

It is yet a further objective of the present invention to provide a device for securing a lid to a pot that can be used with lid handles of different shapes and sizes (round or square knob, C-ring, recessed, etc.).

It is yet a further objective of the present invention to provide a device for securing a lid to a pot which is easy to use.

To accomplish the objectives set forth above, the present invention provides a lid securing device that secures a lid to the mouth of a pot. The lid securing device includes a first support piece and a second support piece. Each support piece is made of a fabric material. Each support piece has an upper and a lower panel that are attached together, with a space between each pair of upper and lower panels. The lid securing device further includes first and second adjustable strap systems, with each strap system having a portion that extends in the space between each pair of upper and lower panels of the first and second support pieces, with the portion of the first strap system crossing the portion of the second strap system in each of the spaces between each pair of upper and lower panels. Each strap system further includes a fastener that allows the length of the strap system to be adjusted.

### BRIEF DESCRIPTION OF THE DRAWINGS

FIG. 1 is an exploded perspective view of a securing device according to one embodiment of the present invention shown in use with a cooking pot.

FIG. 2 is an exploded perspective view of a fastener that can be used with the securing device of FIG. 1.

FIG. 3 is an exploded perspective view of a modification that can be made to a support panel.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

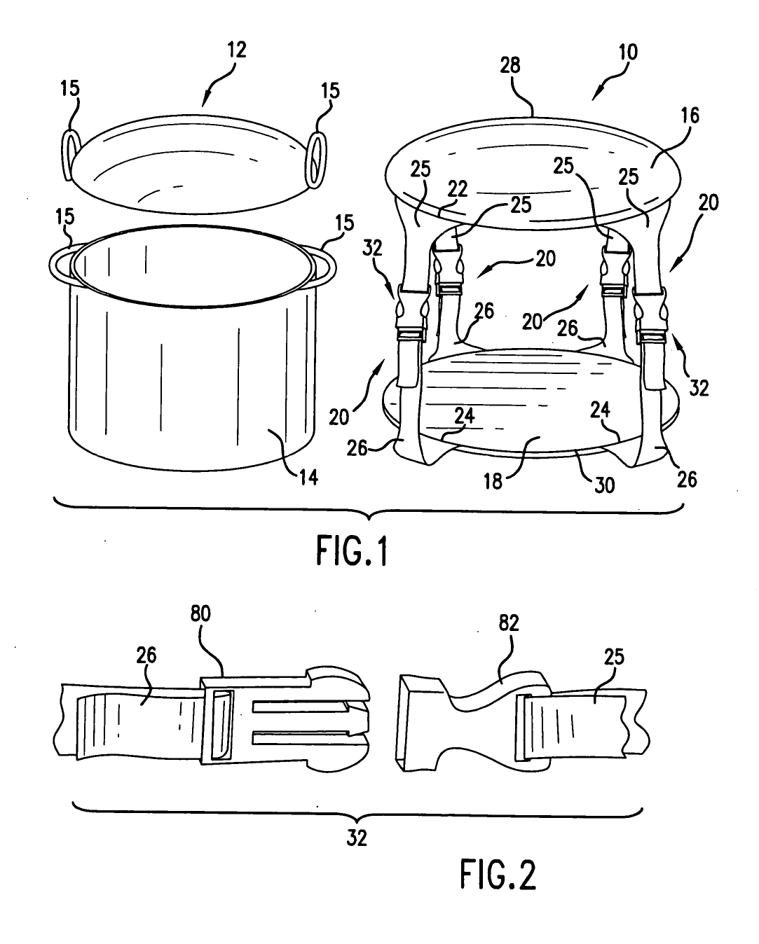

FIG. 1 illustrates a securing device 10 that can be used to secure a lid 12 to the opened mouth of a pot 14. Handles 15 can be provided on the lid 12 and/or the pot 14. The securing device 10 includes two support pieces 16 and 18 positioned one above the other that are connected by opposite ends of four adjustable strap assemblies 20. The support pieces 16, 18 can be provided in a tough fabric material that can resist wear and tear, and non-limiting examples include nylon or Cordura™. The support pieces 16, 18 are preferably circular in shape, although they can be provided in other shapes (e.g., square) as well. The support pieces 16, 18 can have a diameter of about 3-4 inches, and a thickness of about 1/16 of an inch.

As shown in FIG. 1, each strap assembly 20 can be identical, and has a first strap section 25 that defines one end 22, and a second longer strap section 26 that defines an opposite end 24, with the ends 22, 24 connected (e.g., by stitching) to the peripheral edge 28 and 30 of the support pieces 16 and 18, respectively. The strap assemblies 20 are connected at spaced-apart locations along the peripheral edges 28, 30 in a manner such that they are spaced apart equi-distant from each other. For example, if the support pieces 16, 18 are circular, the strap sections 25, 26 are positioned at the zero degree, 90 degree, 180 degree and 270 degree positions along the peripheral edge 28, 30 of the circle.

Each strap assembly 20 further includes a whistle-like fastener 32 that can be any conventional whistle-like fastener used in conventional backpacks and bags. The fastener 32 can have a plug section 80 and a socket section 82, as best shown in FIG. 2. The plug section 80 is connected to the strap section 26, and the socket section 82 is connected to the strap section 25. Each combined length of the strap sections 25, 26 and the fastener 32 can be about 24 inches long, one inch wide, and have a thickness of about ⅛ of an inch. Each strap section 26 extends through the plug section 80 in a manner such that the plug section 80 allows the length of the strap section 26 to be adjusted.

In use, food is placed in the pot 14, and the lid 12 is placed over the mouth of the pot 14. The sections 80, 82 of the fasteners 32 are then disengaged to separate the support pieces 16, 18, and the pot 14 and the lid 12 are placed on top of the lower support piece 18. The upper support piece 16 is placed over the top of the lid 12, and the sections 80, 82 of the fasteners 32 engaged to connect the support pieces 16, 18. The length of the strap sections 26 can then be adjusted via the plug section 80 so that the pot 14 and its lid 12 are snugly fitted between the support pieces 16, 18. Therefore, pots and lids having different sizes and shapes, and having different characteristics, can all be accommodated for use with the securing device 10. In other words, if the strap assemblies 20 are provided with a sufficient length, the securing device 10 can function as a “one-size-fits-all” device for securing a wide variety of pot and lid combinations.

In addition, the tough fabric material used for the support pieces 16, 18 allow the securing device 10 to withstand contact with the hot surfaces of the lid 12 and the pot 14. The fabric material allows the securing device 10 to be machine washable. The adjustable nature of the securing device 10 will not place any undue stress on, and therefore not damage, the pot 14 and the lid 12.

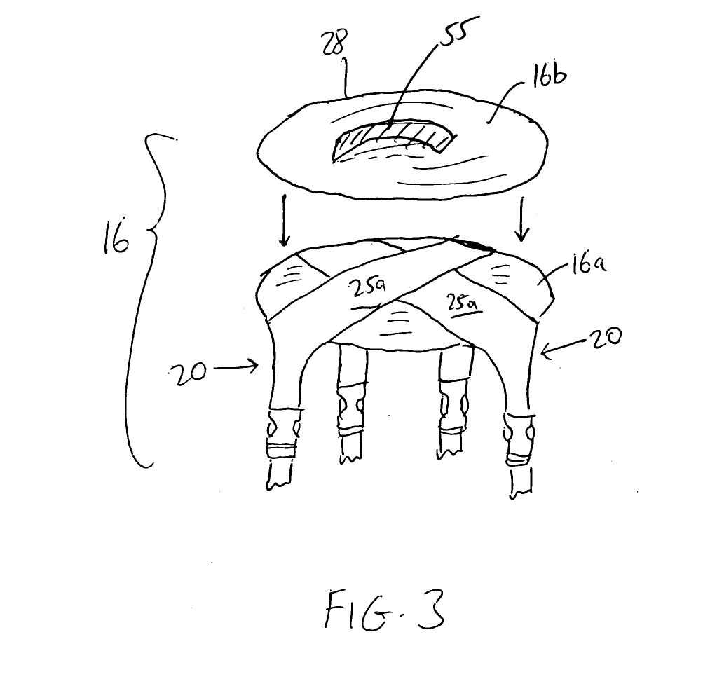

FIG. 3 illustrates a modification that can be made to the support pieces 16, 18. FIG. 3 illustrates the support piece 16, but the support piece 18 can have the same construction. Instead of securing the ends 22, 24 of the strap sections 25, 26 to the peripheral edges 28, 30 of the support pieces 16 and 18, it is possible to provide the support piece 16 in the form of two separate panels 16a and 16b. Each panel 16a, 16b can be made from the same material described above for the support pieces 16, 18. In addition, the ends of opposing strap assemblies 20 extend into the space between the panels 16a, 16b to a point where these ends can even be connected, or formed as a single piece. As a result, as best shown in FIG. 3, the portions 25a of the strap assemblies 20 actually overlap or cross-over each other between the panels 16a, 16b at about the center thereof, and the portions 25a can be stitched or otherwise secured to one or both of the panels 16a, 16b (e.g., to the top surface of the panel 16a and/or to the bottom surface of the panel 16b). The panels 16a, 16b can be attached to each other by stitching the edges 28, 30. By causing the strap assemblies 20 to extend through the support pieces 16, 18, and by utilizing a crossing pattern for the strap assemblies 20 at about the center of the support pieces 16, 18, added support is provided to the support pieces 16, 18, thereby allowing the securing device 10 to be used with a heavier pot 14 (i.e., a pot 14 that contains more food).

In addition, a handle 55 can be provided on the top of the support piece 16 to allow the user to lift the combined pot 14 and securing device 10. The handle 55 can be made of a tough fabric material that is sewn or stitched to the top surface of the piece 16b.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A lid securing device, comprising:
a first support piece and a second support piece, each support piece made of a fabric material and having a peripheral edge, each support piece having an upper and a lower panel that are attached together, with a space between each pair of upper and lower panels;
first and second adjustable strap systems, with each strap system having a portion that extends in the space between each pair of upper and lower panels of the first and second support pieces, with the portion of the first strap system crossing the portion of the second strap system in each of the spaces between each pair of upper and lower panels; and
each strap system further including a fastener that allows the length of the strap system to be adjusted.

2. The device of claim 1, wherein the strap systems are spaced apart equi-distant from each other along the peripheral edges of the first and second support pieces.

3. The device of claim 1, wherein each fastener can be disengaged to separate the first and second support pieces.

4. The device of claim 1, further including a handle provided on the first support piece.

5. In combination:
a pot having a mouth;
a lid fitted over the mouth of the pot;
a lid securing device, comprising:
a first support piece and a second support piece, each support piece made of a fabric material and having a peripheral edge, each support piece having an upper and a lower panel that are attached together, with a space between each pair of upper and lower panels;
first and second adjustable strap systems, with each strap system having a portion that extends in the space between each pair of upper and lower panels of the first and second support pieces, with the portion of the first strap system crossing the portion of the second strap system in each of the spaces between each pair of upper and lower panels; and
each strap system further including a fastener that allows the length of the strap system to be adjusted; and
wherein the first support piece is positioned above the lid and the second support piece is positioned below the pot, with the length of the strap systems adjusted to ensure that the lid is secured snugly to the mouth of the pot by the first and second support pieces.

6. The combination of claim 5, wherein the strap systems are spaced apart equi-distant from each other along the peripheral edges of the first and second support pieces.

7. The combination of claim 5, wherein each fastener can be disengaged to separate the first and second support pieces.

8. The combination of claim 5, further including a handle provided on the first support piece.

9. A method of securing a lid to the mouth of a pot, comprising:
providing a pot having a mouth;
fitting a lid over the mouth of the pot;
providing a lid securing device, comprising:
a first support piece and a second support piece, each support piece made of a fabric material and having a peripheral edge, each support piece having an upper and a lower panel that are attached together, with a space between each pair of upper and lower panels;
first and second adjustable strap systems, with each strap system having a portion that extends in the space between each pair of upper and lower panels of the first and second support pieces, with the portion of the first strap system crossing the portion of the second strap system in each of the spaces between each pair of upper and lower panels; and
each strap system further including a fastener that allows the length of the strap system to be adjusted;
positioning the first support piece above the lid and positioning the pot on top of the second support piece; and
adjusting the length of the strap systems to ensure that the lid is secured snugly to the mouth of the pot by the first and second support pieces.
